(19) United States
(12) Patent Application Publication
(10) Pub. No.: US 2018/0299087 A1
(43) Pub. Date: Oct. 18, 2018

(54) WICK STRUCTURE HAVING WIND BLOWING EFFECT FOR ELECTRONIC CANDLES

(71) Applicant: Liangfeng DIAO, Ningbo City (CN)

(72) Inventor: Liangfeng DIAO, Ningbo City (CN)

(21) Appl. No.: 15/591,482

(22) Filed: May 10, 2017

(30) Foreign Application Priority Data
Apr. 17, 2017 (CN) 201720401164.4

(51) Int. Cl. F21S 10/04; F21V 23/04; F21V 15/01

(52) U.S. Cl. CPC F21S 10/046; F21S 6/001; F21V 15/01; F21V 23/04

(57) ABSTRACT

The present utility model relates to a wick structure having wind blowing effect for electronic candles, comprising: a wick casing, a wick cap, and a swing component, wherein a magnet is provided at a bottom of the wick cap, the swing component includes an integrated circuit and coils, a support pole and a LED lamp are provided in the wick casing, a support hole is opened on the wick cap, and a bottom of the wick casing is connected with a metal tube in which a power source is provided.

### FIELD OF THE INVENTION

The present utility model relates to the technical field of electronic candles, and particularly to a wick structure having wind blowing effect for electronic candles.

### BACKGROUND OF THE INVENTION

In daily life, a situation often occurs where candlelight is needed to decorate the atmosphere. With the continuous development of science and technology, the defects of traditional candles are constantly exposed. For example, the traditional candles have a high-temperature flame and continuously increase the carbon dioxide content in the air. Moreover, the traditional candles are lighted by open fire, produce a lot of heat, and are easier to dump and ignite flammable materials, so there is a great safety risk. In addition, the resource utilization of candles is low, which does not meet the requirements for energy saving and environmental protection. Furthermore, the light intensity and service life of traditional candles usually cannot meet the practical needs in life. As a result, electronic candles emerge accordingly.

Since the emergence of electronic candles, the electronic candles are preferred by more and more people due to their safety, convenience, energy saving, and environmental protection during use. Especially in Europe and America, the electronic candles trend to replace the traditional candles gradually, and more and more electronic candles become available at present. For example, Chinese Patent No. 201220408803.7 discloses an electronic candle lamp, which includes a housing, a lamp cap provided in the housing, and a swing mechanism, where a power base is provided below the housing, and the power base is fixed with an integrated chip thereon; and the swing mechanism includes an upper lamp cap and a lower lamp cap, in which the upper lamp cap is flat and internally provided with a first luminous body fixed to the lower lamp cap by means of a bracket. In the above swing candle, a structure in which the first luminous body is provided on the lamp cap is employed to simulate the effect of a candle. However, because the lamp cap is constantly wobbling, the light source on the electronic candle is caused to wobble ceaselessly, such that the electronic candle is quite dazzling during use, the vision of the user may be harmed easily in use, and the wobble simulation effect is undesirable.

### SUMMARY OF THE INVENTION

In view of the state of the prior art, the technical problem to be solved in the present utility model is to provide a wick structure having wind blowing effect for electronic candles, which can not only meet the lighting demand of the user and can simulate the traditional candle during use.

The technical solution employed in the present utility model for solving the above technical problem is as follows. A wick structure having wind blowing effect for electronic candles includes a wick casing, a wick cap, and a swing component provided in the wick casing. A magnet is provided at a bottom of the wick cap. The swing component includes an integrated circuit and coils provided on the integrated circuit and opposite to the magnet. A support pole and a LED lamp electrically connected to the integrated circuit are provided at a top position in the wick casing. A support hole is opened on the wick cap, and the wick cap is provided, through the support hole and the support pole, at the top of the wick casing in a swing manner. A bottom of the wick casing is connected with a metal tube in which a power source is provided. One end of the integrated circuit runs into the metal tube and is electrically connected to the power source, and a connecting spring butting against the metal tube is provided on the end of the integrated circuit. A power switch electrically connected to the power source is provided at a bottom of the metal tube, and a metal sheet is provided between two terminals of the power switch and the metal tube.

Further, the support hole is integrally provided with a sharp protrusion in a vertical direction, and a notch corresponding to the sharp protrusion is provided on the support pole. The support pole supports the wick cap with the sharp protrusion and the notch, in which the sharp protrusion is docked with the notch to form a support point on the support pole for supporting the wick cap, whereby wobbling of the wick cap is achieved under the action of the magnet and the coils.

Further, the metal tube is an aluminum tube, such that the power source, the integrated circuit board, and the power switch form a circuit loop.

Further, the wick casing is integrally provided with a fixture holder for securing the LED lamp at a position corresponding to the LED lamp, and also internally integrally provided with a fixture block for position restraining of an electric connecting wire of the LED lamp to the integrated circuit, thereby achieving the effect of fixing the LED lamp.

Further, the support pole is “T” shaped, the wick casing is integrally provided with a symmetrical mounting slot at the top thereof at a position corresponding to the support pole, and two arms of the support pole are arranged in the mounting slot.

Further, an enclosure made of an insulation material is jacketed outside the wick casing and the metal tube, through which an external aesthetic effect is achieved, and electric shock of the users is avoided.

Compared with the prior art, the present utility model has the following advantages. In the present utility model, the LED lamp is provided internally at the top of the wick casing, and the light emitting from the LED lamp is projected with the aid of the wick cap, thereby achieving a normal lighting effect. Meanwhile, in the present utility model, the support hole of the lamp cap is sleeved on the support pole, and a support point for supporting the wick cap is formed by the sharp protrusion on the support hole and the notch on the support pole; and swing of the wick cap is realized by the magnet at the bottom of the wick cap under the action of a magnetic field generated by the coils when energized (by utilizing the “tumbler” principle), whereby a wind blowing effect is achieved without dazzling while the normal lighting is ensured. The present utility model has reasonable design, can meet the market demand, and is suitable for generalization.

### BRIEF DESCRIPTION OF THE DRAWINGS

FIG. 1 is a schematic cross-sectional diagram of a structure of the present utility model; and

FIG. 2 is a schematic structural diagram of a wick cap and a lamp pole of the present utility model.

### DETAILED DESCRIPTION OF THE INVENTION

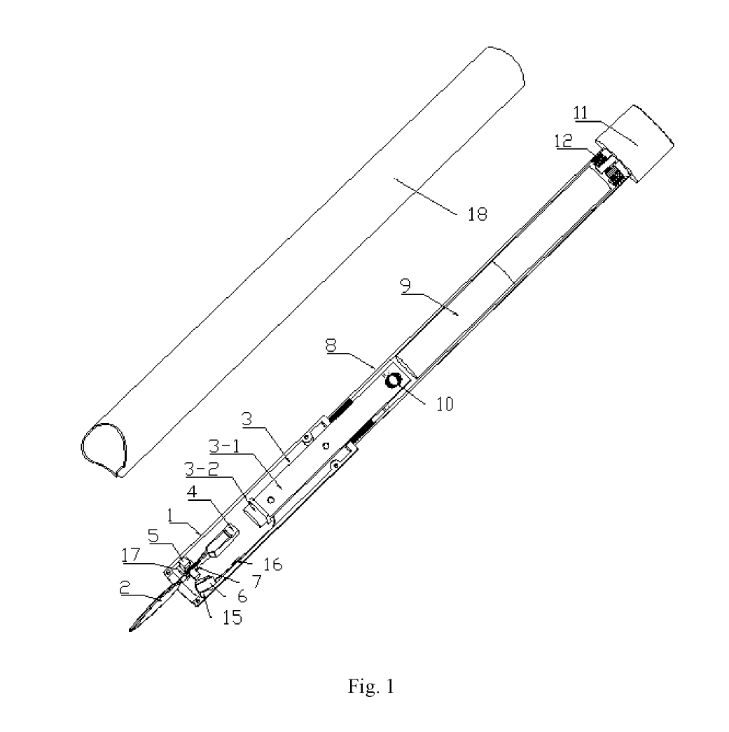

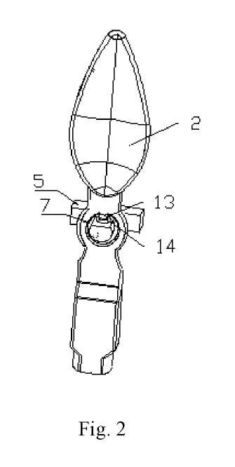

As shown in FIGS. 1-2, a wick structure having wind blowing effect for electronic candles includes a wick casing 1, a wick cap 2, and a swing component 3 provided in the wick casing 1. A magnet 4 is provided at a bottom of the wick cap 2. The swing component 3 includes an integrated circuit 3-1 and coils 3-2 provided on the integrated circuit 3-1 and opposite to the magnet 4. A support pole 5 and a LED lamp 6 electrically connected to the integrated circuit 3-1 are provided at a top position in the wick casing 1. The wick casing 1 is integrally provided with a fixture holder 15 for securing the LED lamp 6 at a position corresponding to the LED lamp 6, and also internally integrally provided with a fixture block 16 for position restraining of the electric connecting wire of the LED lamp 6 to the integrated circuit 3-1, thereby achieving the effect of fixing the LED lamp 6. The support pole 5 is “T” shaped, and the wick casing 1 is integrally provided with a symmetrical mounting slot 17 at the top thereof at a position corresponding to the support pole 5, where two arms of the support pole 5 are arranged in the mounting slot 17. A support hole 7 is opened on wick cap 2, and the wick cap 2 is provided, through the support hole 7 and the support pole 5, at the top of the wick casing 1 in a swing manner. Moreover, the support hole 7 is integrally provided with a sharp protrusion 13 in a vertical direction, and a notch corresponding to the sharp protrusion 13 is provided on the support pole 7. The support pole 7 supports the wick cap 2 with the sharp protrusion 13 and the notch 14, in which the sharp protrusion 13 is docked with the notch 14 to form a support point on the support pole 5 for supporting the wick cap 2, whereby wobbling of the wick cap is achieved under the action of the magnet 4 and the coils 3-2. A bottom of the wick casing 1 is connected with a metal tube 8 in which a power source is 9 provided. One end of the integrated circuit 3-1 runs into the metal tube 8 and is electrically connected to the power source 9, and a connecting spring 10 butting against the metal tube 9 is provided on the end of the integrated circuit 3-1. The metal tube 8 is an aluminum tube. Moreover, A power switch 11 electrically connected to the power source 9 is provided at a bottom of the metal tube 8, and a metal sheet is provided between two terminals of the power switch 11 and the metal tube 8, such that the power source 9, the integrated circuit board 3-1, and the power switch 11 form a circuit loop. An enclosure 18 made of an insulation material is jacketed outside the wick casing 1 and the metal tube 8, through which an external aesthetic effect is achieved, and electric shock of the users is avoided.

In the present utility model, the LED lamp is provided internally at the top of the wick casing, and the light emitting from the LED lamp is projected with the aid of the wick cap, thereby achieving a normal lighting effect. Meanwhile, in the present utility model, the support hole of the lamp cap is sleeved on the support pole, and a support point for supporting the wick cap is formed by the sharp protrusion on the support hole and the notch on the support pole; and swing of the wick cap is realized by the magnet at the bottom of the wick cap under the action of a magnetic field generated by the coils when energized (by utilizing the “tumbler” principle), whereby a wind blowing effect is achieved without dazzling while the normal lighting is ensured. The present utility model has reasonable design, can meet the market demand, and is suitable for generalization.

Finally, it should be noted that the above embodiments are merely illustrative of and are not to be construed as limiting the technical solutions of the present utility model. Although the present utility model has been described in detail with reference to the foregoing embodiments, it will be understood by those skilled in the art that modifications may be made to the technical solutions or equivalent replacements may be made to part of the technical features described in the embodiments, without departing from the spirit and scope of the technical solutions of the various embodiments of the present utility model.

1. A wick structure having wind blowing effect for electronic candles, comprising: a wick casing, a wick cap, and a swing component provided in the wick casing, a magnet being provided at a bottom of the wick cap, and the swing component including an integrated circuit and coils provided on the integrated circuit and opposite to the magnet, wherein a support pole and a LED lamp electrically connected to the integrated circuit are provided at a top position in the wick casing; a support hole is opened on the wick cap, and the wick cap is provided, through the support hole and the support pole, at the top of the wick casing in a swing manner; a bottom of the wick casing is connected with a metal tube in which a power source is provided; one end of the integrated circuit runs into the metal tube and is electrically connected to the power source, and a connecting spring butting against the metal tube is provided on the end of the integrated circuit; and a power switch electrically connected to the power source is provided at a bottom of the metal tube, and a metal sheet is provided between two terminals of the power switch and the metal tube.

2. The wick structure having wind blowing effect for electronic candles according to claim 1, wherein the support hole is integrally provided with a sharp protrusion in a vertical direction, a notch corresponding to the sharp protrusion is provided on the support pole, and the support pole supports the wick cap with the sharp protrusion and the notch.

3. The wick structure having wind blowing effect for electronic candles according to claim 1 or 2, wherein the metal tube is an aluminum tube.

4. The wick structure having wind blowing effect for electronic candles according to claim 3, wherein the wick casing is integrally provided with a fixture holder for securing the LED lamp at a position corresponding to the LED lamp, and also internally integrally provided with a fixture block for position restraining of an electric connecting wire of the LED lamp to the integrated circuit.

5. The wick structure having wind blowing effect for electronic candles according to claim 4, wherein the support pole is “T” shaped, the wick casing is integrally provided with a symmetrical mounting slot at the top thereof at a position corresponding to the support pole, and two arms of the support pole are arranged in the mounting slot.

6. The wick structure having wind blowing effect for electronic candles according to claim 1, 4 or 5, wherein an enclosure made of an insulation material is jacketed outside the wick casing and the metal tube.
